(19) United States
(12) Patent Application Publication
(10) Pub. No.: US 2007/0166221 A1
(43) Pub. Date: Jul. 19, 2007

(54) Nanocarbon fulerenes (ncf), method for producing ncf and use of ncf in the form of nanocarbons

(76) Inventors: Christian Schonefeld, Geilenkirchen (DE); Rolf Stein, Huckelhoven (DE); Volodymyr Padalko, Kiev (UA); Gunther Mathar, Stolberg (DE)

Correspondence Address: WILLIAM COLLARD;COLLARD & ROE, P.C., 1077 NORTHERN BOULEVARD, ROSLYN, NY, 11576, US

(21) Appl. No.: 10/586,241

(22) PCT Filed: Jan. 14, 2005
(86) PCT No.: PCT/DE05/00042

§ 371 Date: Aug. 23, 2006

(30) Foreign Application Priority Data
Jan. 17, 2004 (DE) 10 2004 002 566.5
Aug. 24, 2004 (DE) 10 2004 041 146.8

(51) Int. Cl. C01B 31/02

(52) U.S. Cl. 423/445 B; 977/741

(57) ABSTRACT

Despite intensive research and numerous essays and reports, chemical and physical methods of producing fullerene structures of carbon modifications could heretofore only be carried out on a laboratory scale. The invention suggest a new family of nanomaterials, more specifically of carbon hybrids, namely nanostructured carbon fullerenes (NCF). Methods of production and methods of use thereof are being proposed and illustrated using numerous examples. The proposed NCF and their nanocompounds are very well suited for industrial production and in particular in highly technological applications.

The invention relates to nanocarbon fullerenes (NCF), to a method of producing NCF and to the use of NCF in the form of nanocompounds. NCF are a new family of nano materials, more specifically of carbon hybrids.

A plurality of prior art laboratory, chemical and physical methods are known for producing fullerene structures of various modifications such as for example carbon modifications through combustion reactions of hydrocarbon compounds (see Kronto et. al., Nature 1985, 318; Harris, European Microscopy, Sep. 13, 1994).

Other materials have been presented, containing condensed structures consisting of carbon with diamond-like and non diamond-like modifications, in which the crystalline and X-ray amorphous carbon phases contain compact spheroids having diameters of approximately 7 nm as well as tubes having a diameter of about 10 nm (see Jonan Notura & Razuro Kavamura, Carbon 1984, Ed. 22, N2, p. 189 and followings; Van Triel & Mand Ree, F. H. J. Appl. Phys. 1987, Ed. 62, pp. 1761-1767; Roy Greiner et al., Nature 1988, Ed. 333 dated Jun. 2, 1988, pp. 440-442).

The radiogram of the carbon modifications that are not diamond-like are characterized by spacings between the intermediate planes on the orders of magnitude of 0.35 nm at reflections (002) that are typical for purely amorphous or stochastically disoriented forms of graphite and that suggest a fullerene-type structure.

The crystal phase of the carbon thereby is a compact spheroid with a diameter of approximately 7 nm with large surface values. Electron fractometric tests yield the following reflection values in the intermediate levels: d=0.2058; 0.1266; 0.1075; 0.8840 and 0.636 nm which correspond to the surface reflection values of the cubic crystal modification of carbon at (111), (220), (400) and (440).

Likewise, methods of producing similar substances from reaction products of highly energetic compounds are known, which are brought to react in inert gas media at atmospheric pressure (see Jonan Notura & Razuro Kavamura, Carbon 1984, Ed. 22, N2, p. 189 and followings; Van Triel & Mand Ree, F. H. J. Appl. Phys. 1987, Ed. 62, pp. 1761-1767; Roy Greiner et al., Nature 1988, Ed. 333 dated Jun. 2, 1988, pp. 440-442).

However, the regimes described do not find corresponding application as industrial processes and are only practicable on a laboratory scale.

Further, highly constructed carbon modifications are known, which consist of the following mass ratios (mass percent): carbon (84.0 to 89.0), hydrogen (0.3 to 1.1), nitrogen (3.1 to 4.3), oxygen (2.0 to 7.1) as well as non-combustible admixtures (up to 0.5) and with carbon in cubic modification (30.0 to 75.0), X-ray amorphous carbon phase (10.0 to 15.0), with the surface of these substances being occupied with methyl, carboxyl, quinone, lactone, aldehyde and ester groups and so on (see patent literature RU No. 2041165 MPK6 SOIV 31/06, published BI No. 22, Sep. 8, 1995; WO 00/78674 A1; WO 02/07871 A2).

Likewise, a method (see DE 199 55 971) of producing carbon modifications with fullerene-type dopants (clusters) are known, in which reactive conversions of high-energy organic compounds with negative oxygen balance take place in closed volumes (reaction containers) as well as in an inert atmosphere with subsequent cooling of the reaction products at temperatures of 200-6000 Kelvin/min. The thus produced carbon modifications show the following cluster structure: in the center of the cluster, there is positioned a core that consists of a cubic crystal phase around which an X-ray amorphous carbon phase organizes, which in turn transforms into a crystalline carbon phase. On the surface of the crystalline carbon phase, there are located chemical residual groups. The ratios produced between the discrete carbon phases and the chemical groups attached to the surface allow for the use of this material as a component of highly-effective composite materials, mainly in the function of an additive for improving the physical-mechanical application characteristics of plastic materials. The addition of for example 1 through 3% of this material in highly-filled elastomers results in the drift behaviour improving by 1.2 to 1.4 times, in mixtures with a low fill, by 2.0 to 5.0 times.

It is the object of the present invention to adapt the crystal structure of the cubic carbon modifications in such a manner that the surface atoms have a considerable share in the total number of carbon atoms, and to form mechanically stable cluster compacts—similar to polycrystalline structures—in the form of “spherical carbonite”. The invention relies on the fact that the fullerene cluster molecular structure of already known substances may be designed much better and modified in a manner providing further possibilities of application in the industrial field.

According to an aspect of the invention, this object is solved by a nanoparticular carbon structure containing carbon in hexagonal and cubic modification as well as oxygen, hydrogen, nitrogen and non-combustible additions, these additions having nanoparticle fullerene formations and being stabilized.

A carbon structure manufactured this way can have a porous volume and pronounced adsorption potentials. In the manufacturing method, the elements used for its production are processed and stabilized preferably by means of chemical-dynamic transformation of organic energy carriers with negative oxygen balance in a closed volume in inert gas atmosphere under atomic hydrogen plasma with subsequent cooling of the reaction products. Usually, the material proposed is a dark grey powder with a specific weight of about 2.3 to 3.0 g/cm³, which corresponds to the value of 65 to 85% of the specific weight of a cubic carbon structure. The X-ray phase analysis ideally locates only one single phase peak, namely the one of the cubic modification of the carbon (diamond).

The microelectronograms of the material of the invention thereby differ from those of the nanosized ultradisperse diamond system produced during the dynamic synthesis by a widened line (111) but also by existing well developed local reflexes which shows that the geometric structure of the crystals is determined by specific and new characteristics.

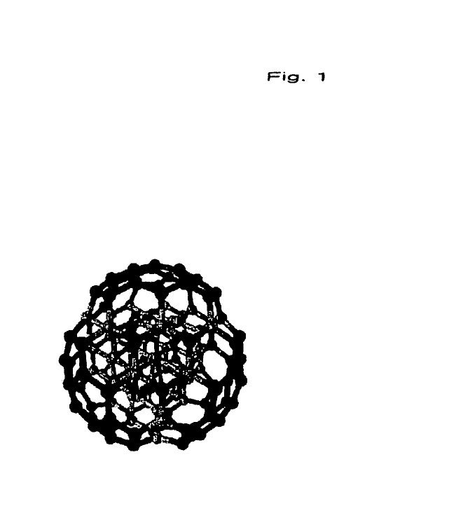

The X-ray scattering pattern is a sign that the central crystals of the cubic grid phase are surrounded by a carbon atom shell (cage) consisting of a regular arrangement of pentagons and hexagons and corresponding to the spatial structure of a “Buckyball”, i.e., of a fullerene morphology (see FIG. 1: light nanometric diamond structure and dark fullerene “caps”).

According to the suggestions of the invention, a nanoparticular substance system can be obtained while producing the carbon with cubic crystal modification by chemical transformation of high-energy compounds, said substance system having particle sizes of 5 to 10 nm, specific surface values of up to 700 m²/g and highest adsorption potentials, in ranges of up to 500 and even of up to 700 J/g, as well as primary and secondary pores with fullerene structure.

As contrasted with natural and synthetic carbon structures with cubic crystal phase (diamond), the absorption spectrum of the fullerene materials has a series of specific peculiarities and the monocrystal may appear colourless. The characteristic grey colour of the clusters is due to diffuse light scatter and reflection. Ideally, there is no optical anisotropy. The electronic structure of the fullerenes present is a sign that they are capable of emitting light of a certain wavelength independent of the size of the crystallites. Nanocrystals made from conventional semiconductive materials, by contrast, usually show significant color change of the light they emit if their diameter is changed within the range of only a few nanometers.

The refraction index may be in ranges of up to more than 2.55, thus being considerably higher than the value of comparable structures.

The absorption limits of the fullerene materials (NCF) in the UV range ideally range from 220 to more than 300 nm as well as up to approximately 2810 cm in the near infrared.

The material particles and clusters preferably have ogival shapes on the inner and outer surface of which open pores may be localized. The dimensions of the open pores determined by BET preferably are 12 to 100 Å; the volume adsorption may achieve values of up to 700 J/g.

In accordance with another aspect of the invention, the thermal treatment of NCF in vacuum or inert gas atmosphere (argon) provides fullerene shells (“OLC” or “onion-like carbons”), with about 1800 to 2000 carbon atoms comprising in the type of a container a nanosized core with cubic crystal structure and 900 to 1000 surface atoms.

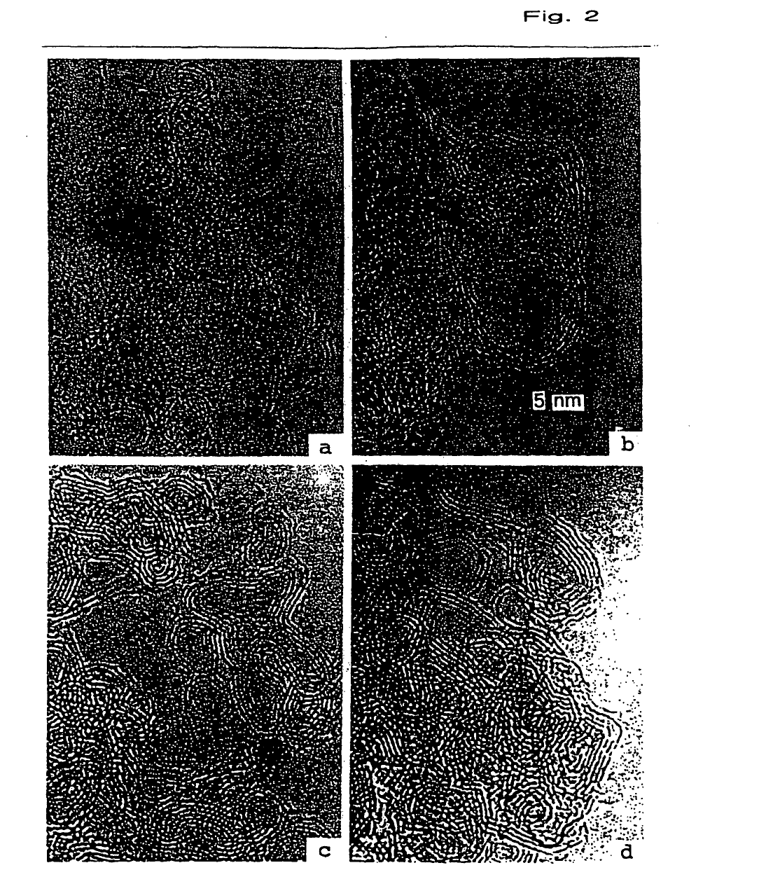

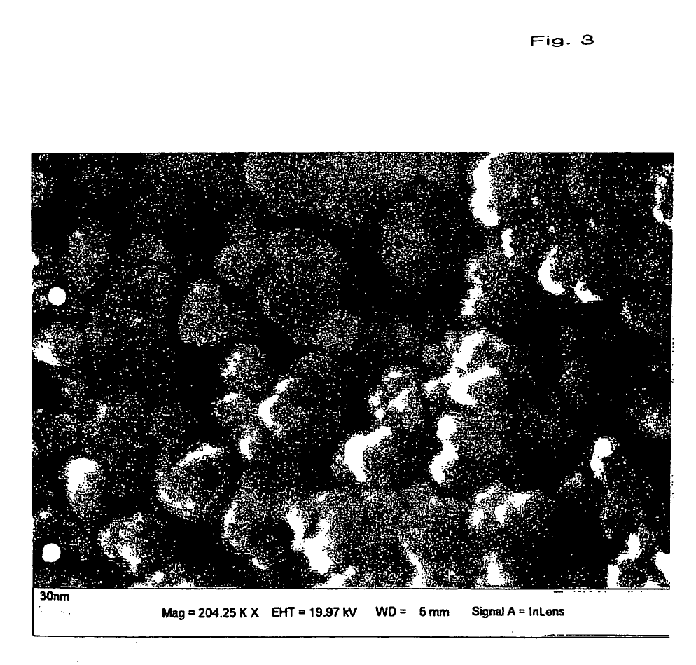

FIG. 2 shows selected TEM-photographs of NCF shells (vacuum; a: 1415 K; b: 1600 K; c: 1800 K; d:2150 K). NCF cluster compounds in dry and powder state are shown in FIG. 3.

The base for the use of NCF-materials as well as for the multi-functional combination of the NCF systems with other nanoparticular materials, primarily with metallic, metal oxidic, oxidic, mineral, organic and other groups of substances, form technologies for the special surface modification of the nanoparticular systems as well as for the production of stable nanocompounds and for optimal enabling in corresponding macrostructures (organic or inorganic matrices and so on).

To solve the problem, it was necessary to characterize the complex dynamics of the NCF-systems in combination with other multifunctional nanoparticles, to detect the interacting forces between the nanoparticles (van der Waals forces of attraction, mass, shape, size of the particles and others), to determine the product states between singularization, dispersion and agglomeration as well as the dependencies of ZETA potential and conductivity, to utilize optimal dispersion steps (method, intensity, duration) as well as adapted technological expedients and resources (media, stabilizing agents) and to build up and put into practice methods of modifying the nanoparticle surfaces.

The decisive process for resolving the problem are purposeful use of technologies for the chemical and physical modification of surfaces of nanoparticular materials as a function of their specific energetic surface characteristics (specific surface, adsorption and ZETA potential) as well as purposefully influencing and designing the hydrophobic or hydrophilic balance.

Aspects of the present invention lead to stable multifunctional nanosized composite compounds with based, aqueous and organic carrier matrices as well as with selected polymers, monomers and oligomers.

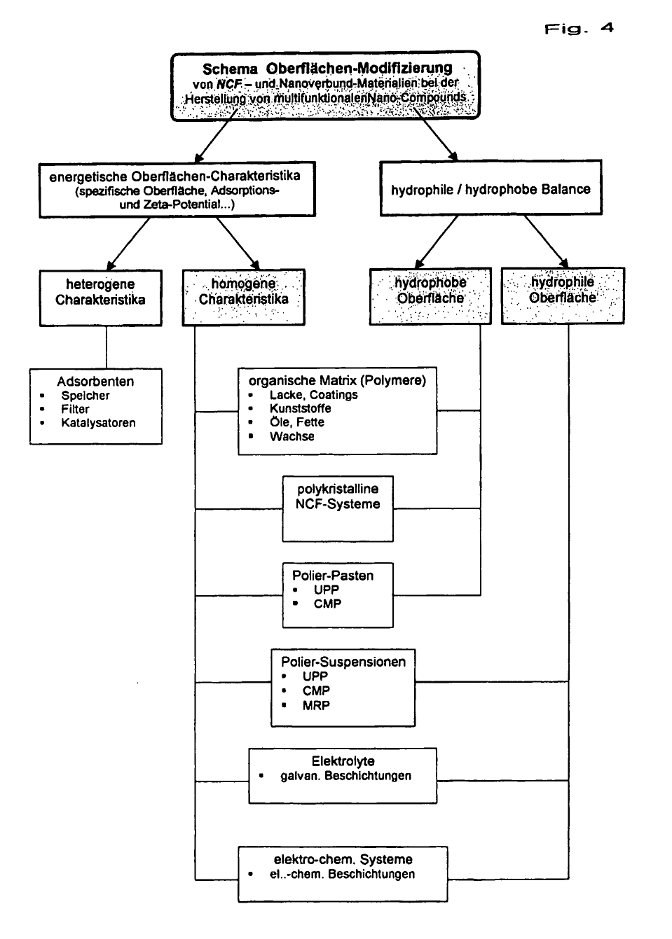

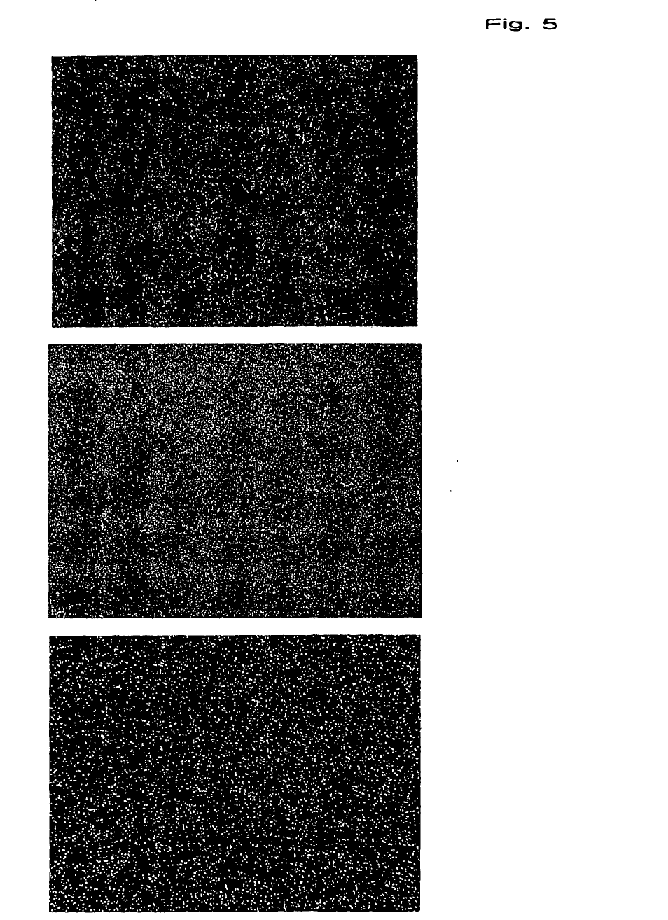

FIG. 4 shows a preferred technological basic diagram with adapted product applications such as: high-performance systems (suspensions, pastes) as nano-compounded end products for ultra precise polishing (UPP, CMP, MRP) of surfaces, primarily of high-performance optics, semiconductor elements of the conductor electronics and super hard crystalline special materials; also, products on an organic base with multivalent improvement of properties (plastic materials, varnishes, coatings, oils, grease, wax, electrochemical/electrolytic coatings, and so on) such as, more specifically with respect to mechanical tribological and chemical characteristics, optical characteristic and performance parameters, antimicrobial and easy-to-clean properties; moreover, for example adsorbing agents, getter memories, filters, catalysis and active substance carriers and others.

FIG. 5 illustrates selected NCF nanocompounds (at a 1000-fold magnification) on an aqueous, polymer and oligomer base.

Further advantages of the aspects of the invention discussed herein above as well as other aspects of the invention will be discussed herein after with reference to six examples.

### EXAMPLE 1

### Industrial Production of Nanocarbon Fullerenes (NCF) with Predominantly Almost Monocrystalline Morphology

A substance combination of organic energy carriers, primarily mixtures of C₇H₅N₃O₆ (oxygen value: −73.9%) and cyclotrimethylenetrinitramine (oxygen value: −21.6%) with a mass of 15 kg is brought to chemical conversion with negative oxygen balance in an enclave chamber having a free space volume of 100 m³.

In this synthesis technology, the reaction chamber consists of three horizontally and axially arranged cylinders, with the central cylinder being designed to be stationary. The two side cylinders are axially slidable by means of an electric drive and ensure energy carrier supply to the central cylinder as well as installation of the initial and cooling system.

The chemical reaction occurs in controlled “inverse shockwaves” (P>7.26×10⁵ bar) in an inert gas atmosphere (<1 bar) in the presence of atomic hydrogen plasma. After the reaction is complete, the synthesis product is rinsed under water pressure and is introduced into a system-integrated collecting reservoir. The cleaning of the NCF-systems, which occurs thereafter, is carried out chemically.

Technological and invention-specific characteristics are more particularly as follows:

Production of highly pure nanoparticular carbon structures in the condensed aggregate state by means of chemical conversion of combined, solid, liquid and hybrid, highly energetic carbon donor compounds utilized in accordance with the invention with negative oxygen balance.

At first, formation of the short-term physical transformation of the hexagonal carbon crystal grid structure into the cubic (diamond grid) as well as into the fullerene spatial grid structure (“cage” structure with>>C₂₄₀) according to the martensite mechanism through: realizing a topological temperature platform of 3,000 to 4,500° C.; implementing a local pressure level of at least 4.5 GPa; forming dynamic inverse shockwaves in the range of more than 100,000 atm as well as limiting the short-term physical reaction time of chemical conversion to a maximum of 7.5×10⁶ s. Moreover, the fullerene structures produced are prevented from regraphitizing by forming atomic hydrogen plasma for the duration of the chemical reaction process.

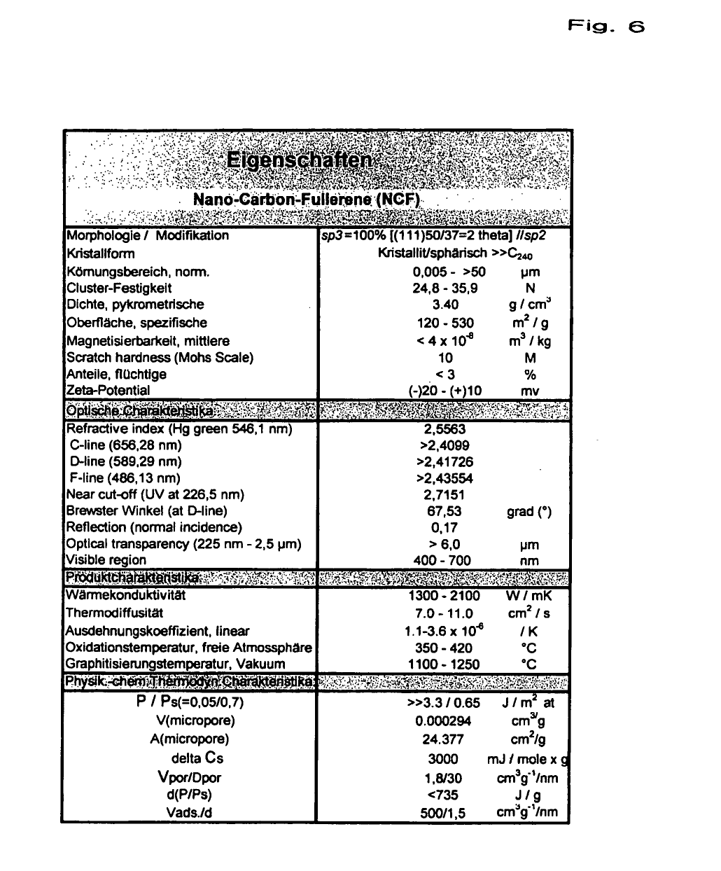

The most important properties and characteristics of NCF and the innovation and application potentials connected therewith are shown in FIG. 6.

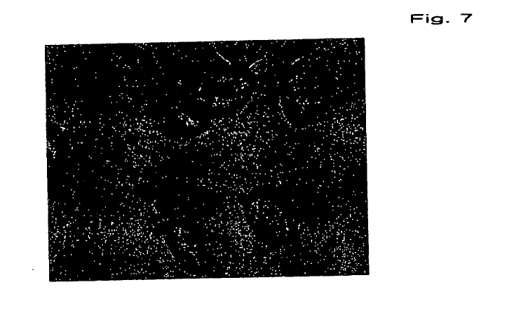

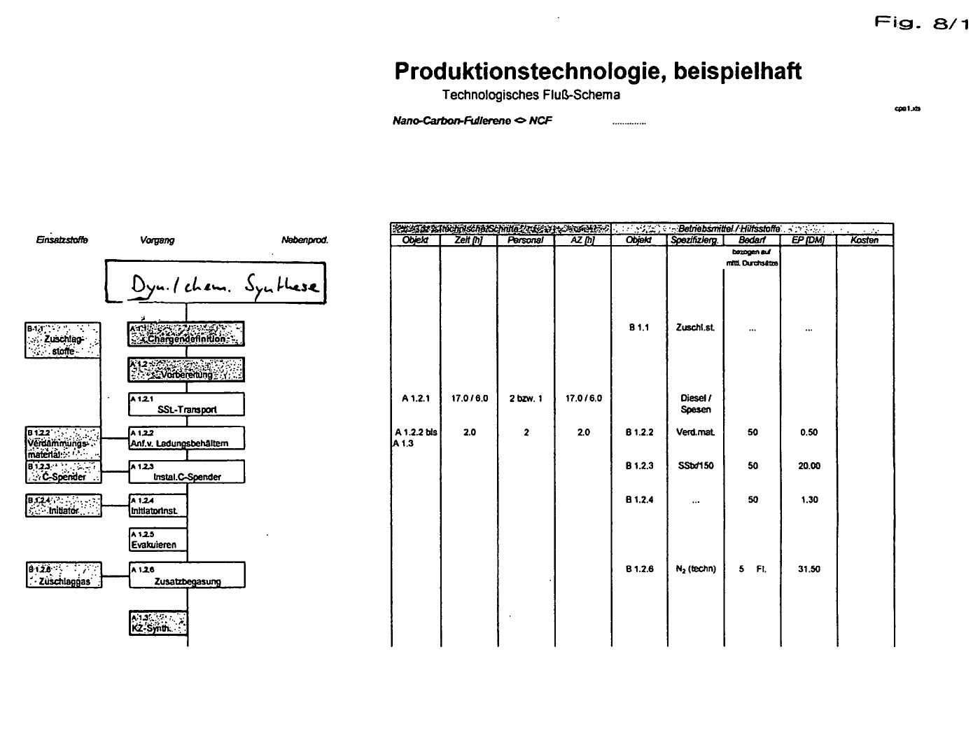

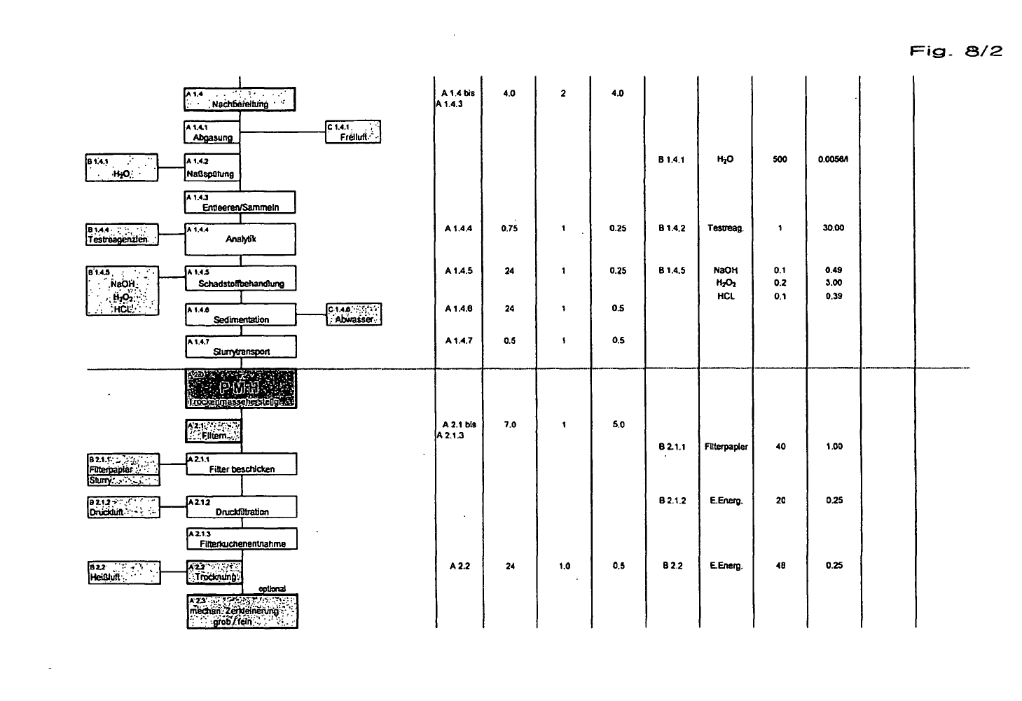

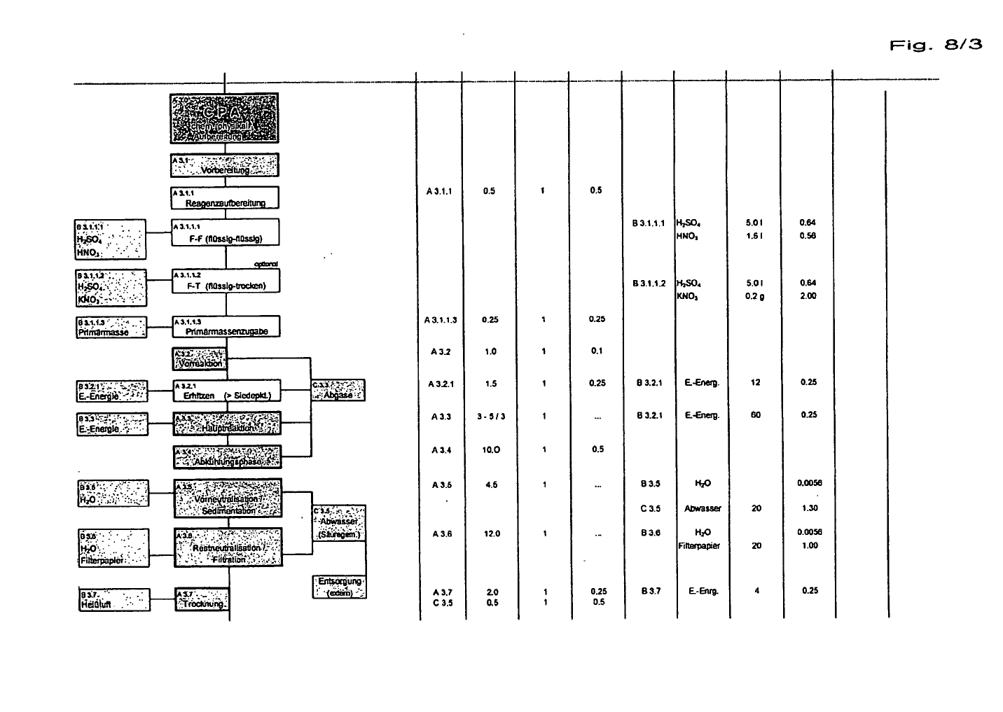

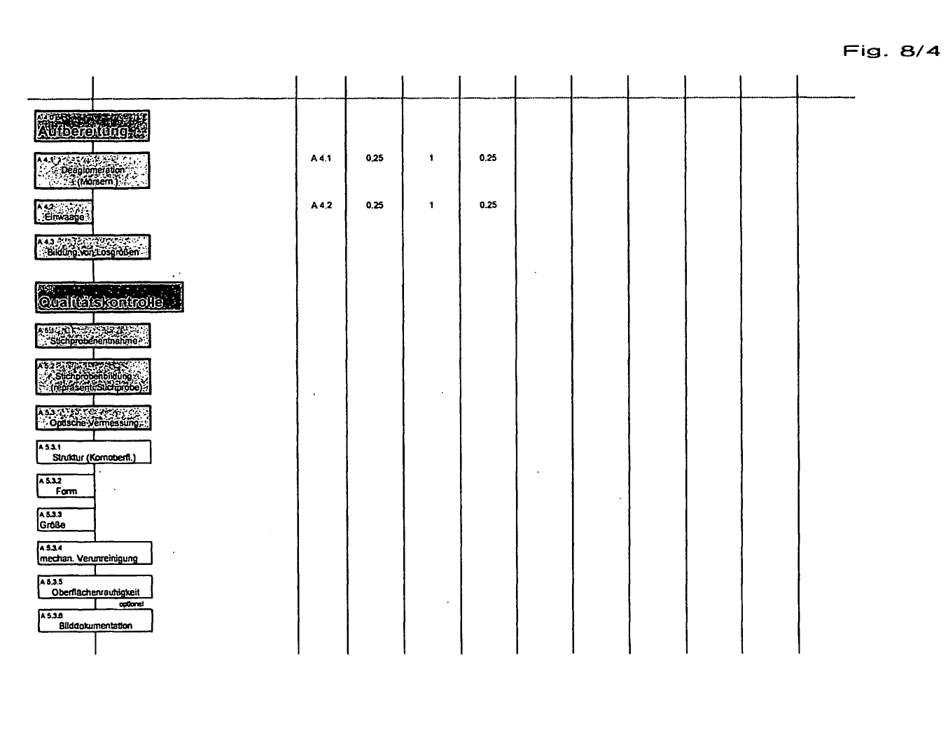

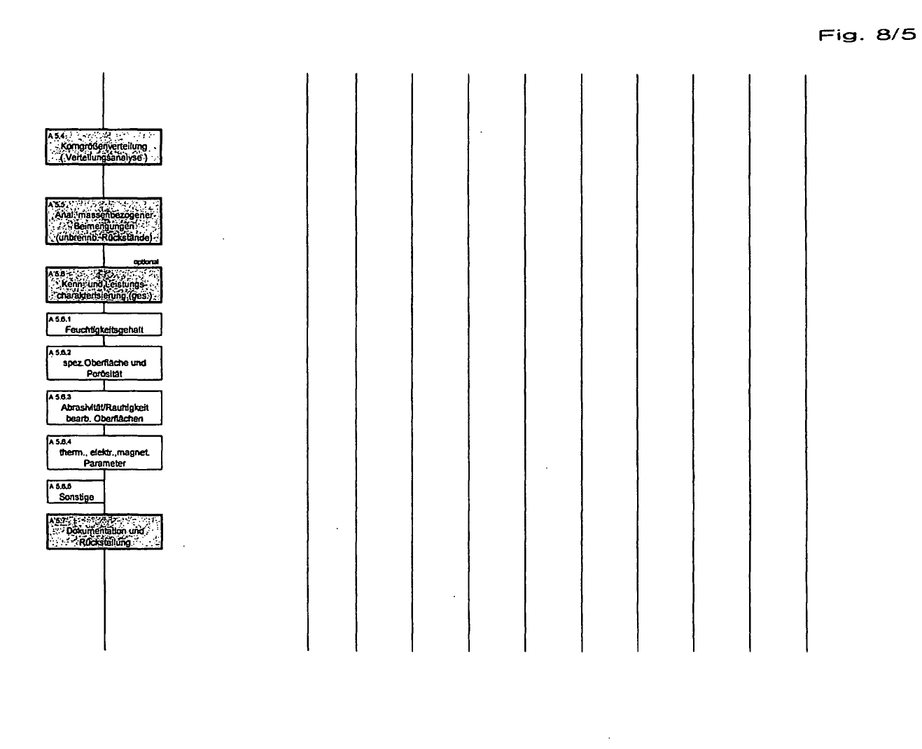

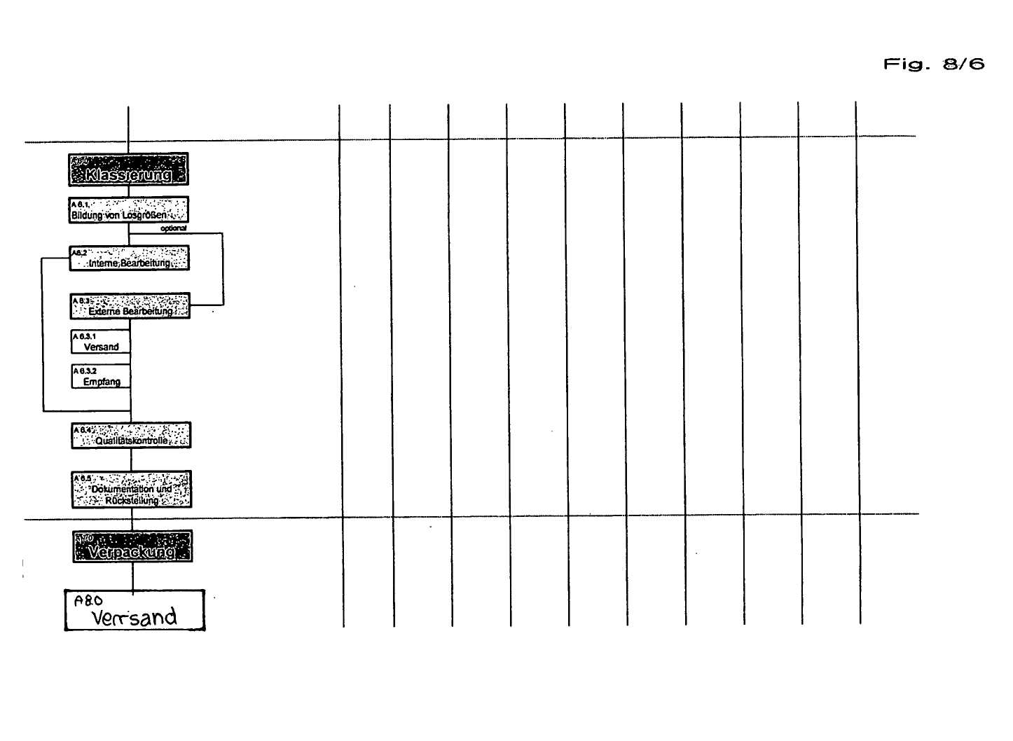

In FIG. 7, NCF is optically illustrated by means of TEM. The FIGS. 8/1 through 8/6 show a preferred technological flow chart of the synthesis process.

### EXAMPLE 2

### Industrial Production of Nanocarbon Fullerenes with Polycrystalline Morphological Structure (Poly-, NCF, PNCF)

In a subsequent technological method step, NCF with primarily almost monocrystalline morphology are formed into polystructured NCF in accordance with the invention, using a CVD (Chemical Vapor Deposition) assisted sintering process in a special high pressure vacuum system at pressures ranging from 8.0 to 10.5 GPa and at temperatures ranging from 1,000 to 1,500° C. with subsequent mechanical communition, chemical processing and corresponding grain size classification.

Technological and invention-specific characteristics are the following:

At first, a carbon-type carrier gas, preferably methane, is diffused into the spatial pore system of the NCF structures.

Further, there is formation of the sp³ hybridization under the following formation parameters: mass velocity in g/cm²/s according to the calculation term 537.4 exp [−2.68×10⁵/RT]×CRT/16; linear velocity in m/s according to the calculation term 2.67 exp [−2.68×10⁵/RT]×CRT/16; wherein R is the universal gas constant, C the carbon concentration in the gas phase in g/cm³ and T the temperature in K.

FIG. 9 shows the TEM photograph of polystructured NCF having grain sizes ranging from 2.0 to 5.5 μm. A preferred production technology is schematically illustrated in FIG. 10.

### EXAMPLE 3

### Production and Use of Multifunctional NCF Compounds Combined with Nanoparticles for Improving the Mechanical Properties of Lacquers (Coatings) Using the Example of the 2K-PUR Mat Lacquer System

In accordance with an aspect of the invention, finished lacquer systems are modified with NCF particles using an indirect method in which the nanoparticles are first predispersed in a solvent that should be, as far as possible, polar and slightly viscous and that is already a constituent part of the lacquer. These predispersed substances are next utilized to modify lacquer systems.

To modify the 2K-PUR mat lacquer, n-butyl acetate is for example utilized as the predispersed substance, which contains 10% of monocrystalline NCF particles and 2% of the dispersion excipient Disperbyk 2150 (solution of a block copolymer with basic groups having pigment affinity). The monocrystalline particles are first dispersed in an ultrasonic bath (2×600 W/Per., 35 kHz) and next with ultrasonic flow equipment (HF output 200 W, 20 kHz). To remove possible impurities, a screen with a mesh width of 65 μm is utilized.

At first, 500 g of the 2K-PUR lacquer (component 1) are placed into a beaker and then 100 g of sub-μm glass flakes (glass platelets of boron silicate glass, mean size 15 μm) and 15 g of nanoparticular Aerosil® R972 (hydrophobed, pyrogenic SiO₂, mean size of the primary particles 16 nm) are added thereto. The additives are dispersed in the ultrasonic bath—here: glass platelets 30 min and Aerosil® R972 for 60 min. Next, 5 g of the predispersed n-butyl acetate are added by stirring and homogenized again in the ultrasonic bath for a period of 60 min. The finished nano-compound provides for corresponding multifunctional improvement of the complex mechanical characteristics and performance data of the mat lacquer system.

The application (enabling) of the modified lacquer occurs according to the manufacturer's instructions, the prescribed amount of curing agent (component 2) being added to the modified component 1.

In tests, changes in the surface textures (mat lacquers have such an irregular fine surface structure that the light is scattered in all directions and that there is hardly any reflection) and in the complex mechanical characteristics and the crosslinking density of the modified lacquer system and of the reference lacquer system (non modified) were compared inter alia.

After machine treatment with nonwoven steel wool with commercially available abrasive and polishing paste, the surface texture was evaluated microscopically at 100 times magnification and through determination of the roughness values by means of a Mahr Perthometer M4Pi according to DIN EN ISO 4287.

The roughness values determined—more specifically the average roughness Rₐ—are indicative of substantial improvement of the abrasion resistance and the Martens hardness value of the modified lacquer. As compared to the reference lacquer, the texture (mat finish) of the lacquer surface is not subject to changes or to negligible changes only after the mechanical loads. These results are reflected in the microscopic evaluations.

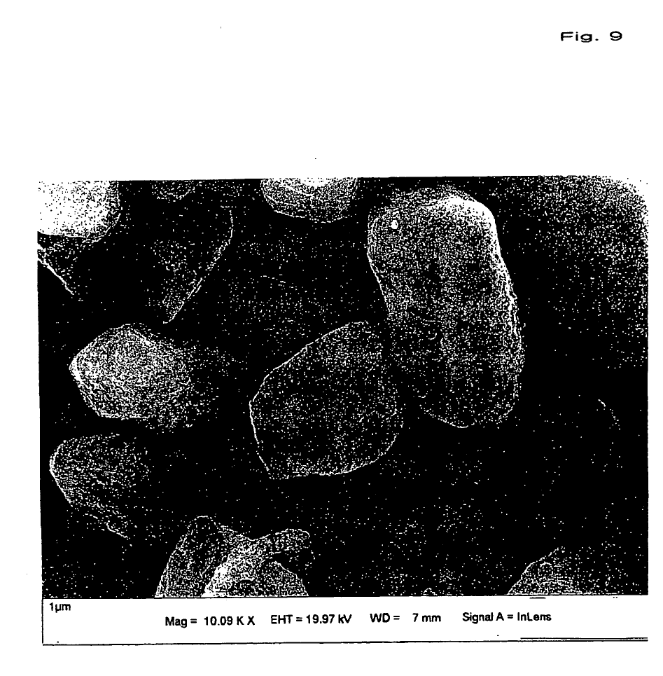

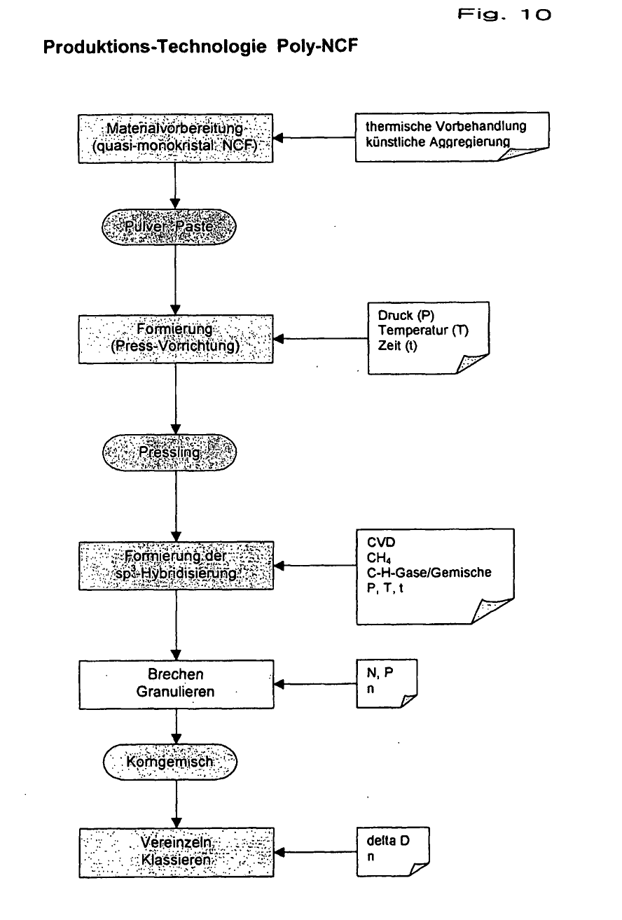

FIG. 11 clearly shows the improved abrasion resistance and surface texture of the NCF-improved lacquer systems by comparison; FIG. 12 shows the increase of the Martens hardness values and the improved abrasion resistance.

### EXAMPLE 4

### Production and Use of Multifunctional NCF Compounds Combined with Nanoparticles for Improving the Tribological Properties (Sliding Properties) of Lubricating Lacquer Systems (Solid Lubricants) Using the Example of an NCF Modified Acrylate Lacquer on Water Basis

In accordance with an aspect of the invention, finished lacquer systems are modified with NCF particles using an indirect method in which the nanoparticles are first predispersed in a solvent that should be, as far as possible, polar and slightly viscous and that already is a constituent part of the lacquer. These predispersed substances are further utilized to modify lacquer systems.

The acrylic lacquer chosen in the present case is composed of two components. Component 1 contains i.a. the acrylic component (Mowilith), which is very shear sensitive. For this reason, it is the second component that is modified in this case, the constituents thereof substantially serving to adjust the viscosity (thickener).

The mixing ratio is chosen such that component 1 is 86.4 parts and component 2 is 13.6 parts.

To modify component 2, an aqueous predispersed substance is utilized, which contains 5% of monocrystalline NCF particles. The monocrystalline particles are dispersed first in an ultrasonic bath (2×600 W/Per., 35 kHz) and next with ultrasonic flow equipment (HF output 200 W, 20 kHz). To remove possible impurities, a screen with a mesh width of 38 μm is utilized.

200 g of the aqueous predispersed substance are added to 15.3 g of component 2 and 75% of the water are removed by tempering at a temperature of 100° C. in order to adjust viscosity. The modified component 2 is next incorporated into 85 g of component 1 by stirring. For homogenization and stabilization, the modified lacquer is treated for 30 min in the ultrasonic bath, 1.8 g of Tamol® NN8906 are added (naphtalene sulfonic acid condensation product) and the mixture is dispersed anew for 30 min in the ultrasonic bath. Possible impurities are removed with a screen having a mesh width of 180 μm. The finished modified lacquer contains 6.5 wt.-% of NCF particles and 1.3 wt.-% of Tamol® NN8906.

Through modification, the sliding friction values are improved by more than double over the non modified lacquer, with the good abrasion resistance of the acrylate lacquer in the Taber Abrasion Test remaining unchanged.

As compared to commercial PTFE and MOS₂-lubricating lacquer systems, the NCF modified acrylate lacquer has improved sliding friction values, with the abrasion resistance increasing on average by factor of 6. This is an important advantage which will provide its effect of benefit for the user when using lubricating lacquers for solid lubrication, mainly in increased long-time and lifetime lubrication and in economical valorization.

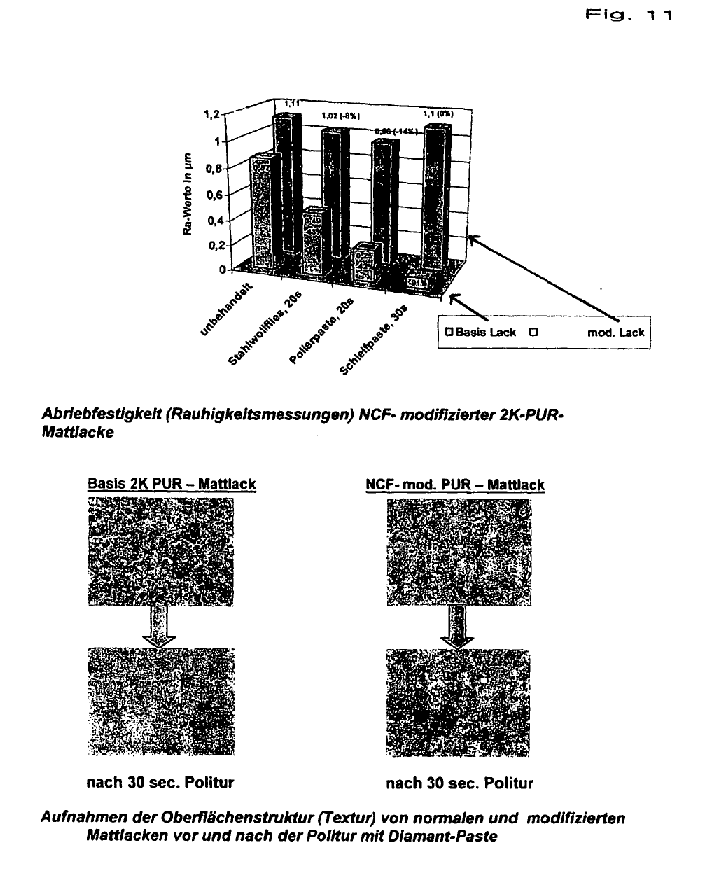

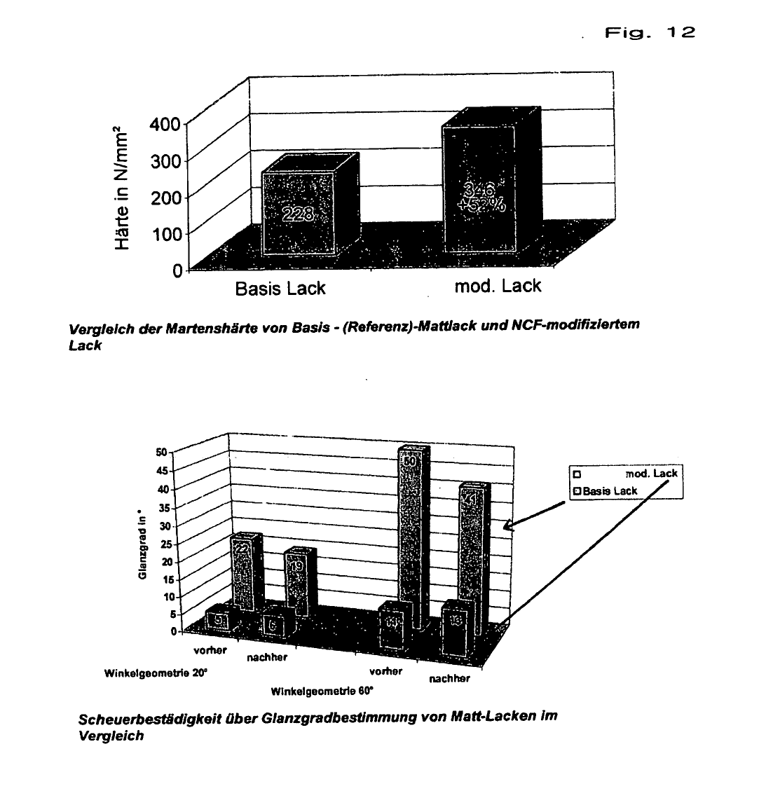

FIG. 13 shows the improved features over the currently commercially available lubricating lacquers and NC hardening lacquers.

### EXAMPLE 5

### Production and Use of an Aqueous Nanosuspension (Nano-compound) for Ultra-Precise-Polishing on the basis of Poly-NCF using the Example of a Grain Size Ranging from 0 to 0.5 μm for Highly Technological Applications

According to another aspect of the invention, an approx. two percent, pH-neutral base suspension is utilized for producing a nanosuspension as a precursor, said suspension being diluted to approx. 1.5% and adjusted to a pH of about 8 using diluted caustic soda lye.

The base suspension is composed of the poly-NCF system with grain sizes ranging between 0 and 0.5 μm, distilled water and the stabilizing agents, the consistency regulator polyvinyl pyrrolidone (PVP or polyvidone 25 (LAB)) and nanoparticular Aerosil® Å300 (pyrogenic SiO₂, mean size of the primary particles 7 nm).

For preparing the suspension, 100 g of the poly-NCF particles are incorporated in portions into 5 kg of water by stirring and are first dispersed for 3 h in an ultrasonic bath (2×600 W/Per., 35 kHz). For further dispersion, the dispersed substance is next treated for 45 min using an ultrasonic flow equipment (HF, output 1000 W, 40 kHz). Separation of possible impurities occurs with a screen with a mesh width of 38 μm.

Stabilization is obtained by adding 250 g of Aerosil® Å300 and 10 g of a five percent aqueous PVP solution. Thereafter, the preparation is again dispersed for 45 min using the ultrasonic flow equipment.

The special pH 8 suspension—approx. 4.8 kg are prepared—is produced by diluting 3.6 kg of the base suspension with 1.2 kg of distilled water (in a ratio of 3:1, w:w) and by subsequently homogenizing this suspension in the ultrasonic bath for 15 min. The pH of the suspension is adjusted to a pH of 8±0.2 using a 1.5% caustic soda lye. An approximate value of 9±2 ml of caustic soda lye per kg of the suspension has been found to be useful.

The following composition of the nanocompound in parts by weight is obtained:

Poly-NCF (0 to 0.5 μm): 1.4%

distilled water: 95%

Aerosil® Å300: 3.6%

Polyridon: 0.007%

NaOH(s): 0.012±0.004%

The properties obtained with this composition are outstanding. The test parameters and performance characteristics obtained by way of example are indicated herein after. The composition was utilized for ultra precise end polishing of planar special stepper optics made from CaF₂.

The tests were carried out as follows:

Test prerequisites: a round CaF₂ part a small area of which is covered with a protective lacquer in order to preserve the state before the etch attack and the removing action of the polish.

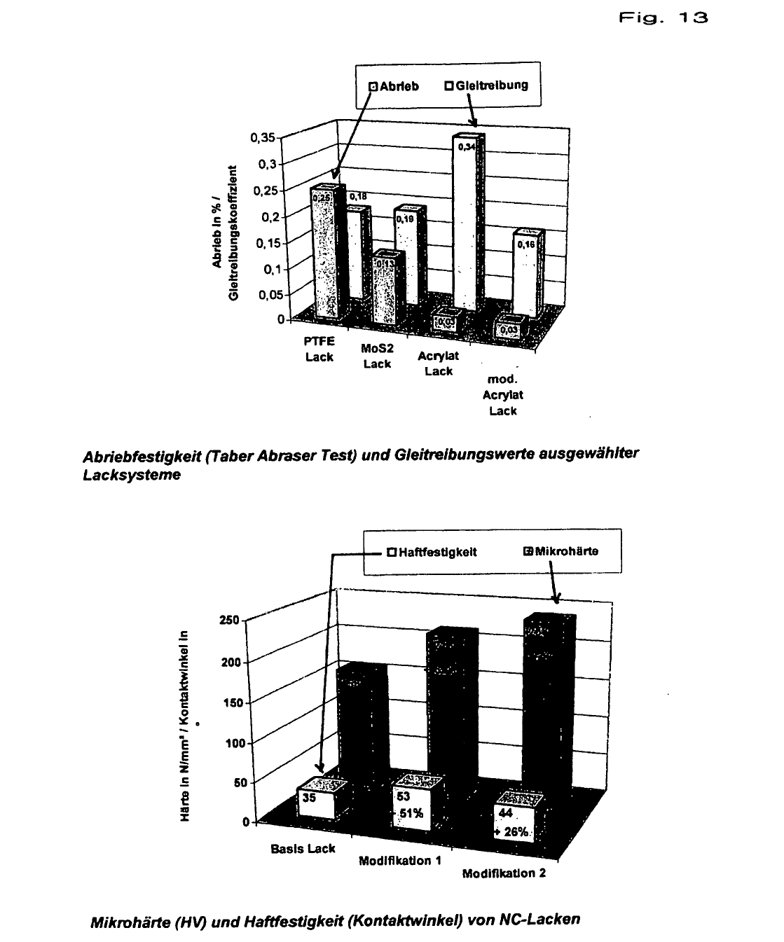

Test run: half of the special optics mentioned before was processed with a rotating tool covered with a soft polishing cloth according to a standard method (see FIG. 14: “standard test for evaluating the polishes”) in order to achieve constant material removal. The optics was processed in vertical meanders, starting from the left border.

Approx. half a liter of the suspension was added during rotation. The processing time was between 30 minutes and 5 hours.

In the same run as described herein above, tests were performed with competing standard products for comparison.

The following results were obtained: the average removal with the new suspension was approximately 800 nm; with standard D0.25 suspensions, it ranged from 30 to 500 nm.

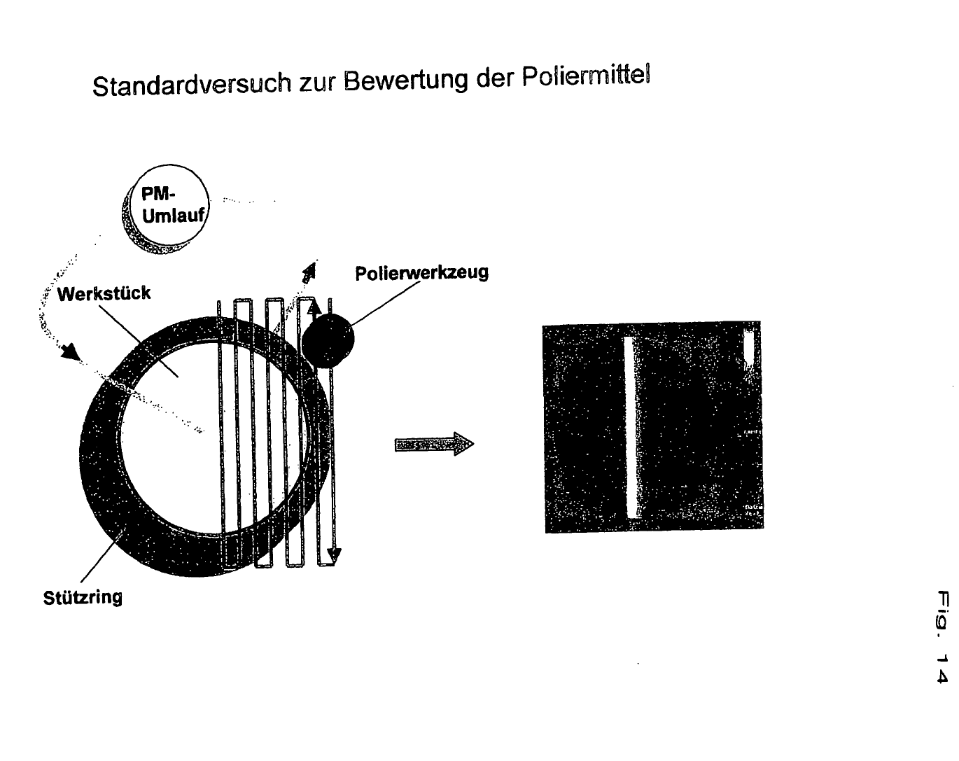

The microroughness achieved (also illustrated in FIG. 15) was approximately 1.1 to 1.2 nm at 2.5 times (with standard D0.25, it was between 1.3 and 1.7 nm), approximately 0.6 to 0.7 nm at 20 times (with standard D0.25, it approximately ranged from 1.1 to 1.7 nm).

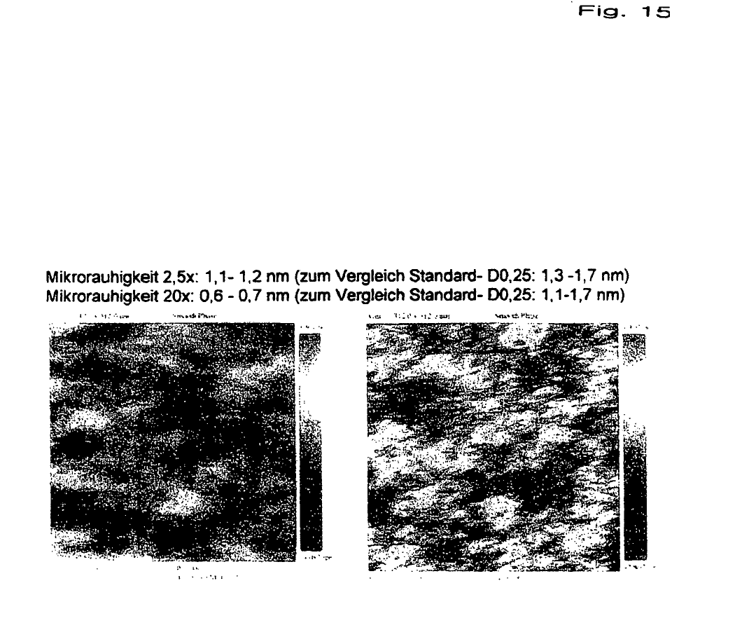

FIG. 16 shows the scratches. With the novel suspension (measured with the dark field microscope at 200 times magnification), there were only a few countable, hardly visible scratches. With standard D0.25, the scratches were more obvious and more visible (see right-hand image).

As compared to other tested suspensions based on diamonds of the 0.25 μm class, the tested novel suspension with poly-NCF constitutes an optimum with regards to material removal, microroughness, passe-forming and scratch topography. It has also been found that the novel suspension permits to compensate for drying by adding water without provoking scratching agglomerates.

As a result, the use of the novel suspension for producing special stepper optics in lithography is also possible beneath the nanotechnology 157 aimed at by the industry.

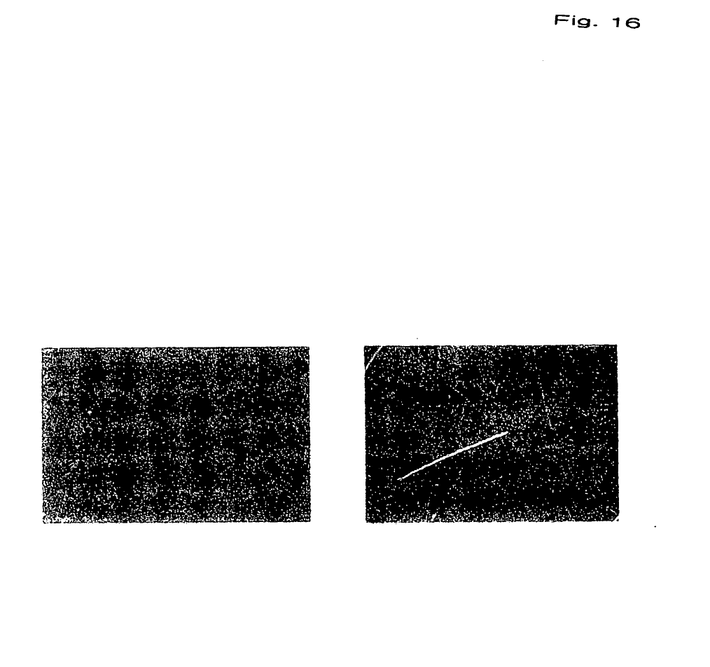

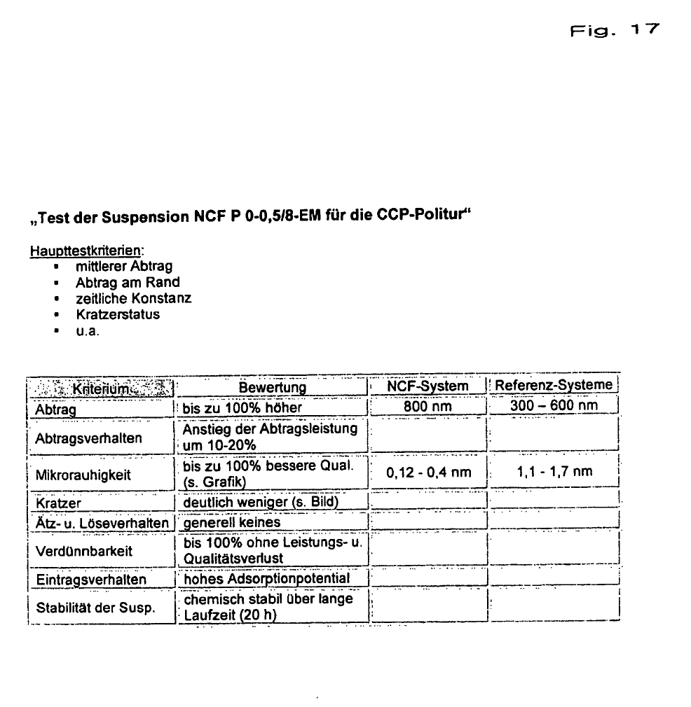

FIG. 17 shows the summarized performance results compared with currently commercialized reference products of ultra polishing systems.

### EXAMPLE 6

### Production and Use of a Water Soluble Poly-NCF Paste (Water-free) for Ultra Precision Polishing Using the Example of a Grain Size Ranging from 0.5 to 1.0 μm for Highly Technological Applications

Using the method in accordance with an another aspect of the invention, the polishing grain having a size of from 0.5 to 1 μm used by way of example is first predispersed in distilled water to produce a water-free polishing paste, consisting of poly-NCF polishing system, binder and consistency regulator.

Next, nanoparticular Aerosil® Å300 (pyrogenic SiO₂, mean size of the primary particles 7 nm, source) is added to the predispersed substance as the consistency regulator and dispersed, a binder—in the instant case polyethylene glycol with a molecular chain length of PEG 400—is added by stirring and the distilled water removed quantitatively.

To produce the predispersed substance, 40 g of the NCF polishing system is added in portions into 2 kg of water by stirring and first dispersed for 2 h in an ultrasonic bath (2×600 W/Per., 35 kHz). To ensure dispersion without agglomerates, the dispersed substance is processed for 40 additional minutes using an ultrasonic flow equipment (HF, output 200 W, 20 kHz). Possible impurities are separated using a screen with a mesh width of 38 μm.

To produce approx. 50 g of the polishing paste, 125 g of the predispersed substance is placed into a beaker, Aerosil® Å300 is added by stirring and dispersed in the ultrasonic bath until no Aerosil flakes are microscopically visible at 100 times magnification—the time needed therefore was 15 min. Next, 38.75 g of polyethylene glycol are added by stirring and the water is removed to leave a residue of less than 0.5% by tempering at a temperature of up to 150° C.

The following composition is approximately obtained in percents by weight:

Poly-NCF (0.5 to 1.0 μm): 5.5%

Aerosil® Å300: 9.5%

PEG 400: 85.0%

To determine the performance characteristics, tests were carried out in the application field of ultra precise end polishing of spherical special stepper optics made from CaF₂ with polishing pads provided with a special pitch coating.

Test prerequisites: round CaF₂ parts with radius 117, bispherical, raised (top and bottom polish) and radius 208, hollow. For top polish, the sides that were not to be processed were coated with a protective lacquer.

Test run: The special optics indicated herein above were clamped into automatic polishing machines. Then, 1 to 2 g of polishing paste were applied, the paste was first distributed by hand with the pitch polishing pad (pad) later used on the machine. Once the paste was evenly distributed, the pad was also clamped into the polishing machine. According to a standard method, the special optics was next processed on its entire surface (with circular and lateral movements and with low weight load of 0.5 to 1 kg). Tests were run identically with competing standard products for comparison.

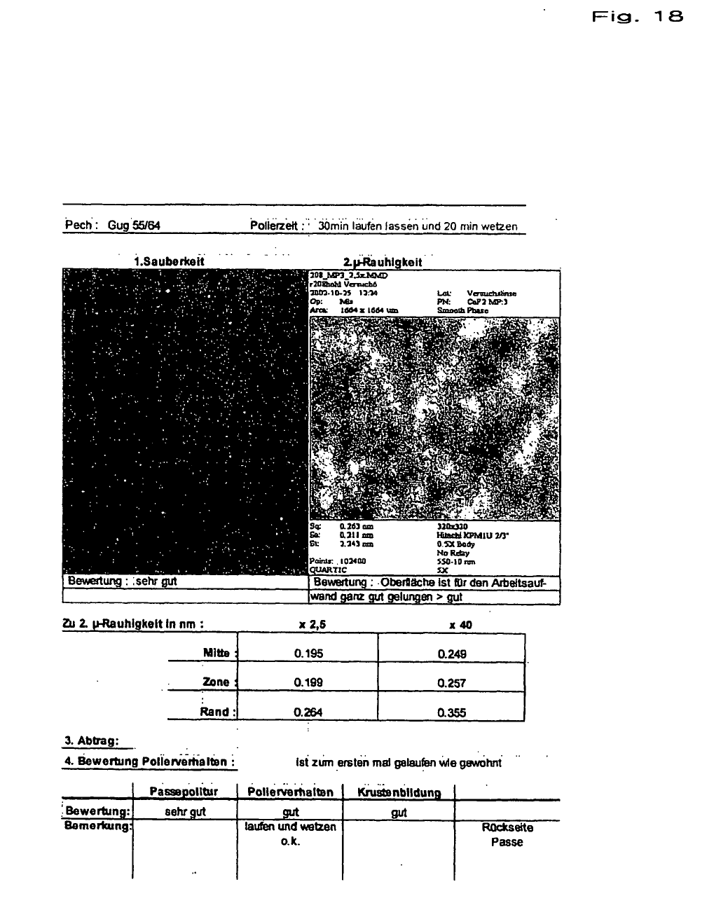

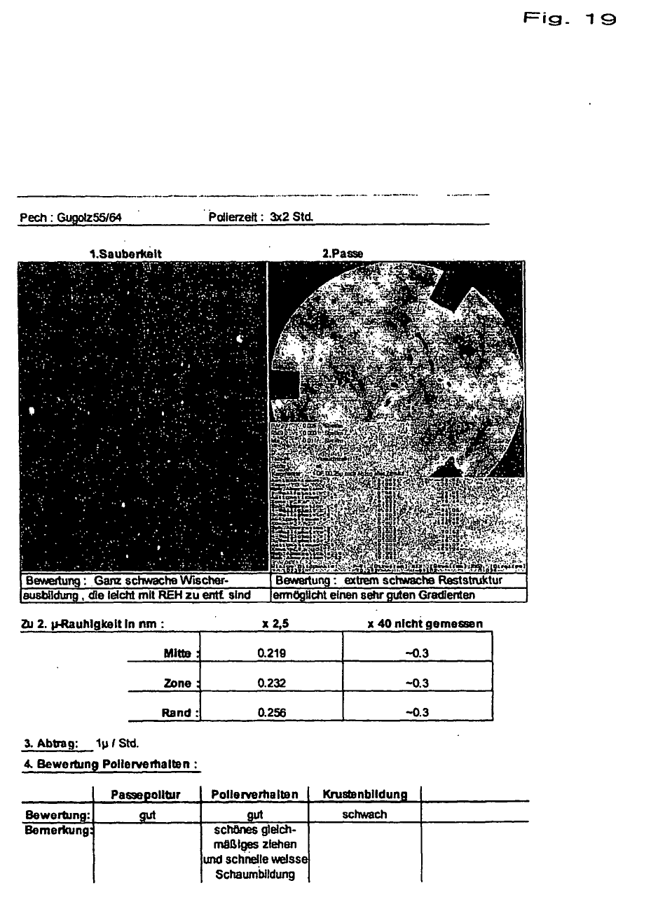

Using the novel paste, an average material removal of approximately 950 nm was achieved over 400 to 600 nm with standard pastes. The microroughness achieved was approximately 0.1 to 0.12 nm at 2.5 times. This is shown in FIG. 18. In comparison, the standard paste achieved approximately 0.2 to 0.6 nm, which is obvious from FIG. 19. At 20 times, approximately 0.4 to 0.6 nm were achieved, using the paste proposed herein. The standard paste yielded results of 0.9 to 1.5 nm.

With the novel paste, measurements with the dark field microscope at 200 times magnification yielded virtually no or hardly visible scratches (see in this context FIG. 18). With the standard paste, the scratches were clearly visible. This is shown in FIG. 19.

Compared with other tested diamond-based pastes of the 0.5 μm class, the tested novel paste with poly NCF constitutes a hereto before unachievable and unknown optimum in terms of material removal, microroughness, passe-forming and scratch topography. It has also been found that the novel paste permits to compensate for drying by adding water without provoking scratching agglomerates.

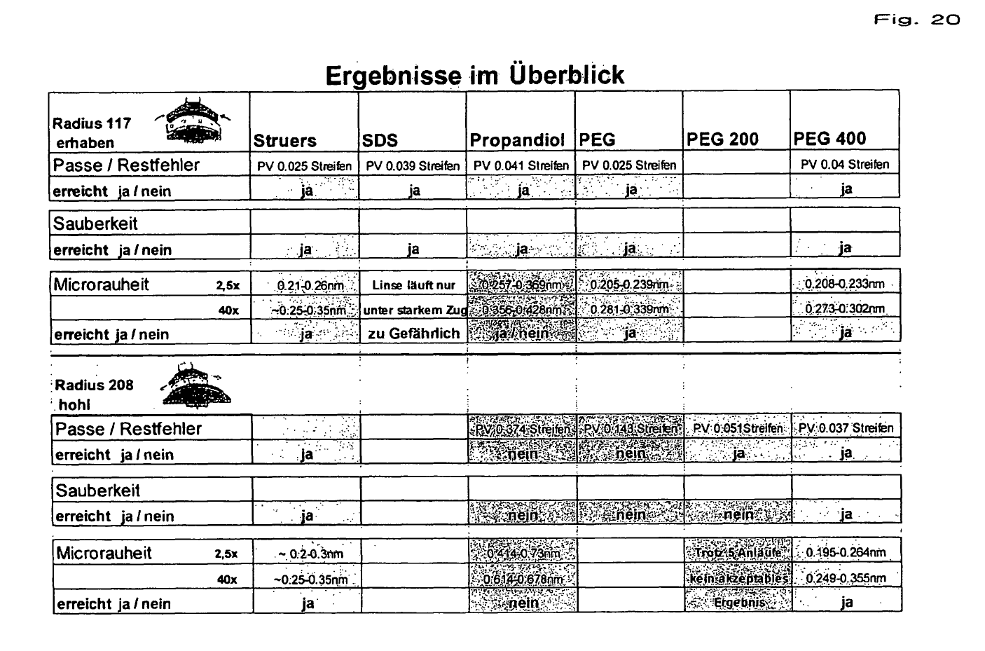

As a result, the use of this paste for producing special stepper optics in lithography is also possible beneath the nanotechnology 157 aimed at by the industry. FIG. 20 shows the corresponding summarized comparative results.

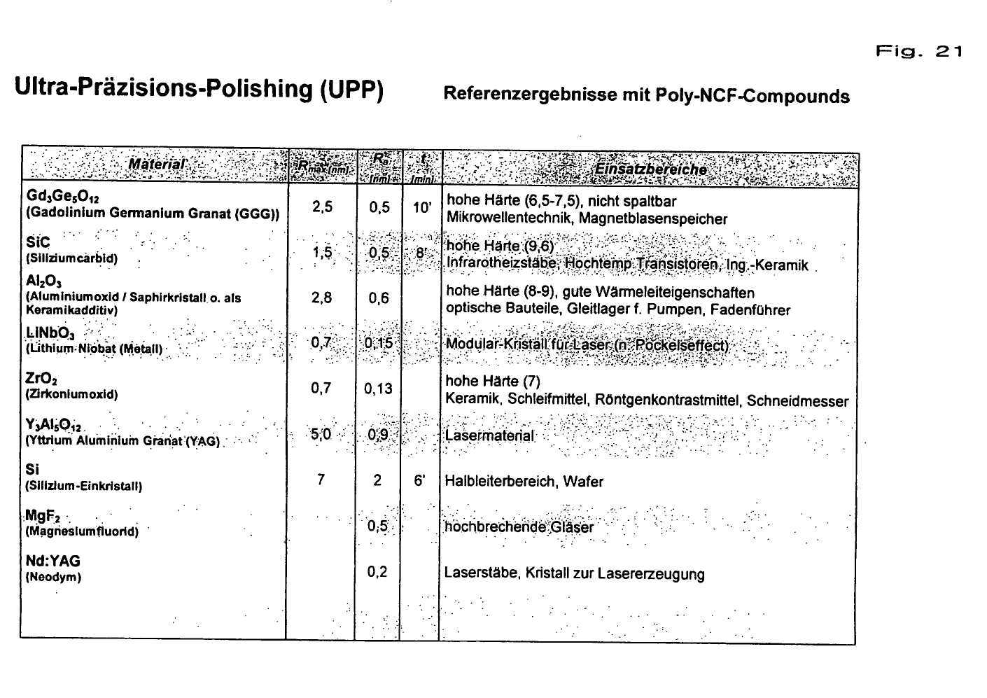

FIG. 21 illustrates further performance results obtained with poly NCF compounds in surface treatment of highly technological materials and elements, primarily in high-performance electronics and optics.

1-30. (canceled)

31. A nanoparticular carbon structure (NCF) with carbon in hexagonal and/or cubic modification as well as with oxygen, hydrogen, nitrogen and non-combustible admixtures which comprise nanoparticular, fullerene formations and are stabilized.

32. The NCF as set forth in claim 31, comprising the following composition of its elements in mass percent: carbon 86.0 to 98.0%, oxygen 1.0 to 6.0%, hydrogen 0.5 to 1.0%, nitrogen 0.5 to 2.0% and non-combustible admixtures 0 to 2.0%.

33. The NCF as set forth in 31, wherein the material particles and clusters have ogival shapes on the inner and outer surface of which open pores are localized.

34. The NCF as set forth in claim 31, wherein open pores have dimensions of 12 to 100 Å according to BET.

35. The NCF as set forth in claim 31, comprising a volume adsorption of at least 300 J/g, preferably of at least 500 J/g and up to 700 J/g.

36. The NCF as set forth in claim 31, comprising a refraction index in excess of 2.55.

37. The NCF as set forth in claim 31, comprising an absorption limit of the material in the UV range of 220 up to more than 300 nm as well as in the near infrared of more than approximately 2810 cm⁻¹.

38. The NCF as set forth in claim 31, wherein it is in the form of a dark grey powder.

39. The NCF as set forth in claim. 38, wherein its specific weight in the noncompacted state ranges approximately between 2.3 and 3.0 g/cm³.

40. The NCF as set forth in claim 31, wherein in X-ray phase analysis, it only delivers one single phase peak, namely that of the cubic modification of the carbon (diamond).

41. The NCF as set forth in claim 31, wherein a formation of central crystals of the cubic grid phase is surrounded by a carbon shell cage, said shell cage consisting of a regular arrangement of pentagons and hexagons.

42. The NCF as set forth in claim 31, wherein the monocrystals appear colorless.

43. The NCF as set forth in claim 31, comprising optical isotropy, light emission at a certain wavelength and with increased refraction index of up to more than 2.55 and adsorption limits in the UV range (220 nm up to more than 300 nm) and near infra-red (>2810 cm) for use in polymer, aqueous and inorganic compound systems for holographic, spatial and planar optical mapping and imaging.

44. A fullerene shell (“onion-like carbon”) in which about 1,800 to 2,000 carbon atoms comprise in the type of a container a nanosized core with cubic crystal structure and about 900 to 1,000 surface atoms, preferably comprising NCF as set forth in claim 31.

45. A method of producing fullerene shells, wherein NCF as set forth in claim 31 is thermally treated in vacuum or in an inert gas atmosphere, in argon atmosphere for example.

46. A method of producing NCF, more specifically NCF as set forth in claim 31, wherein the initial substances carbon, oxygen, hydrogen, nitrogen and non-combustible admixtures are transformed by an organic energy carrier with negative oxygen balance in a closed volume in inert gas atmosphere under atomic hydrogen plasma and that the reaction product is cooled and stabilized thereafter.

47. A method of producing NCF with primarily almost monocrystalline morphology, more specifically as set forth in claim 31, wherein a substance combination of organic energy carriers, primarily mixtures of C₇H₅N₃O₆ (oxygen value: −73.9%) and cyclotrimethylenetrinitramine (oxygen value: −21.6%) with a mass of 15 kg is brought to chemical conversion with negative oxygen balance in an enclave chamber having a free space volume of 100 m³.

48. The method as set forth in claim 47, wherein a short-term physical conversion of the hexagonal carbon crystal grid structure into the cubic structure (diamond grid) as well as into the fullerene spatial grid structure (“cage” structure with >>C₂₄₀) according to the martensite mechanism occurs realizing a topological temperature platform of between 3,000 to 4,500° C.; implementing a local pressure level of at least 4.5 GPa, forming dynamic inverse shockwaves in the range of more than 100,000 atm as well as limiting the short-term physical reaction time of chemical conversion to less than 7.5×10⁶ s.

49. The method as set forth in claim 47, wherein for the time of the chemical reaction, an atomic hydrogen plasma is formed to prevent the fullerene structure produced from regraphitizing.

50. A method of producing NCF with polycrystalline morphological structure (poly-NCF, PNCF), more specifically with NCF as set forth in claim 31, wherein after producing NCF with primarily almost monocrystalline morphology, said NCF is treated using a CVD-assisted sintering process in a vacuum system at pressures ranging between 8.0 and 10.5 GPa and at temperatures ranging from 1,000 to 1,500° C. with subsequent mechanical communition.

51. The method as set forth in claim 50, wherein a carbon containing carrier gas, preferably methane, is diffused into the spatial pore system of the NCF structures.

52. A method of producing a nanoparticle-combined NCF compound, wherein the nanoparticles are first dispersed in a polar and slightly viscous solvent and that, for producing the compound, the predispersed substances are combined with a fluid comprising the same solvent.

53. A lacquer system, more specifically produced in accordance with claim 52, comprising a modification with NCF particles.

54. Use of NCF particles, more specifically according to claim 31, for modifying the mechanical properties of lacquers (coatings), more specifically of 2K-PUR mat lacquer systems.

55. A lubricating lacquer system (solid lubricant) with NCF, more specifically with NCF as set forth in claim 31.

56. Use of NCF, more specifically as set forth in claim 31, for producing a nanoparticle-combined lubricating lacquer system for improving the sliding properties of the lubricating lacquer system.

57. A nanosuspension (nanocompound) on the basis of poly-NCF with the following composition (values given in percent by weight): poly-NCF about 1.4%, distilled water about 95%, Aerosil® Å300 about 3.6%, Polyridon about 0.007% and NaOH(s) 0.012±0.004%.

58. Use of an aqueous nanosuspension on the basis of poly-NCF, more specifically of poly-NCF as set forth in claim 57, for high-precision polishing.

59. Water soluble poly-NCF paste (water-free) with the following substance composition (values given in percent by weight): Poly-NCF about 5.5%, Aerosil® Å300 about 9.5% and PEG 400 about 85.0%.

60. Use of a water soluble poly-NCF paste (water-free), more specifically of a paste as set forth in claim 59, for high-precision polishing, preferably for end polishing of spherical special stepper optics made from CaF₂ with polishing pads provided with a special pitch coating.

61. Use of an NCF system as set forth in claim 40 in polymer, aqueous and inorganic compound systems for holographic, spatial and planar optical mapping and imaging.
